(19) United States
(12) Patent Application Publication
(10) Pub. No.: US 2007/0082223 A1
(43) Pub. Date: Apr. 12, 2007

(54) Stainless steel wire, spring and method of manufacturing the spring

(76) Inventors: Hiromu Izumida, Hyogo (JP); Nozomu Kawabe, Hyogo (JP); Yoshiro Fujino, Hyogo (JP); Teruyuki Murai, Hyogo (JP); Shinei Takamura, Hyogo (JP)

Correspondence Address: MCDERMOTT WILL & EMERY LLP, 600 13TH STREET, N.W., WASHINGTON, DC, 20005-3096, US

(21) Appl. No.: 10/577,765

(22) PCT Filed: Oct. 28, 2004
(86) PCT No.: PCT/JP04/16041

§ 371 Date: Apr. 28, 2006

(30) Foreign Application Priority Data
Oct. 29, 2003 (JP) 2003-369470

(51) Int. Cl. C22C 38/40; B32B 15/02

(52) U.S. Cl. 428/679; 148/327

(57) ABSTRACT

There is provided a stainless steel wire having both excellent corrosion resistance and an excellent fatigue strength while being fabricable with high productivity. A stainless steel wire consists of 0.01 to 0.25 mass % C, 0.01 to 0.25 mass % N, 0.4 to 4.0 mass % Mn, 16 to 25 mass % Cr, 8.0 to 14.0% Ni and the balance Fe with impurities, wherein the C+N content satisfies 0.15 mass % ≦C+N ≦0.35 mass %. The stainless steel wire contains 15 vol. % martensite phase induced by a drawing and the balance austenite phase and has a texture which causes the austenite phase to exhibit diffraction intensities satisfying both I(200)/I(111)≧2.0 and I(220)/I(111)≧3.0 by X-ray diffraction in the longitudinal direction of the steel wire.

### TECHNICAL FIELD

The present invention generally relates to an austenite (γ phase) stainless steel wire, a spring formed from the same stainless steel wire and a method of manufacturing the spring. More particularly, the present invention relates to a stainless steel wire suitable as a material of components or springs required to have both fatigue strengths and corrosion resistance, such as in automobiles and domestic electrical appliances.

### BACKGROUND ART

High-strength stainless steel wires having tensile strengths enhanced by drawing with large degrees of working (reduction in area) are often used as a metal material of springs such as flexing springs or compression springs, torsion bars, reinforcing wires for wire harnesses and high-tensile strength wires for optical fiber cables, etc., which are required to have excellent fatigue strengths and corrosion resistance, out of components used such as in automobiles and domestic electrical appliances.

Patent Literatures 1 and 2 disclose controlling chemical component, grain sizes and shapes of grain and inclusions in dual-phase stainless steels having a ferrite phase and an austenite phase, in order to provide both a high strength (high fatigue strength) and corrosion resistance.

Patent Literature 3 suggests, as a method for enhancing the fatigue strength of austenitic stainless steel wires, that the temperature is controlled during a drawing in order to suppress the production of the strain induced martensite, thus suppressing the occurrence of fatigue cracks and the propagation of cracks due to the production of martensite during the use thereof.

On the other hand, if a stainless steel wire is subjected to a drawing with a great reduction in area, the toughness thereof will be degraded due to the hard drawing, which may cause breakages of the wire during the drawing. Therefore, Patent Literatures 4 and 5 disclose controlling the sizes of inclusions within steels and controlling the amount of inclusion-forming elements contained therein.

Patent Literature 1: JP-B No. 7-91621

Patent Literature 2: JP-A No. 9-202942

Patent Literature 3: JP-B No. 56-033163

Patent Literature 4: JP-B No. 3396910

Patent Literature 5: JP-A No. 11-315350

### DISCLOSURE OF THE INVENTION

Problem to be Solved by the Invention

However, with the aforementioned conventional techniques, there is a limit to the enhancement of corrosion resistance, or there is a limit to the enhancement of the production efficiency even if excellent corrosion resistance can be provided. Therefore, there is a need for more efficient manufacturing of stainless steel wires having both excellent corrosion resistance and excellent fatigue strengths.

The stainless steel wires described in Patent Literatures 1 and 2 can provide higher corrosion resistance than other carbon steel wires. However, these stainless wires are unstable steels containing coexisting two phases and thus cannot be expected to have excellent corrosion resistance equivalent to those of stabilized austenitic stainless steel wires consisting of a single phase that is the austenite phase.

The technique described in Patent Literature 3 includes heating to a specific temperature during the drawing, thereby increasing the working cost.

The techniques described in Patent Literatures 4 and 5 require high-level adjustment of constituents by refining, which may increase the cost. Further, these techniques can provide only extra fine steel wires (products) with wire diameters of 0.5 mm or less in order to achieve a great reduction in area. Thus, the use application is limited.

Therefore, it is a main object of the present invention to provide a stainless steel wire having both excellent corrosion resistance and an excellent fatigue strength while being able to manufacture with high productivity.

Further, it is another object of the present invention to provide a spring manufactured from the aforementioned stainless steel wire with excellent corrosion resistance and excellent fatigue characteristics. Further, it is a further object of the present invention to provide a method of manufacturing a spring which enables production of a spring with an excellent fatigue strength by using the aforementioned stainless steel wire and by further enhancing the tensile strength.

Means for solving problem

The present invention attains the aforementioned objects by specifying the chemical composition and by realizing specific metallographic structure. Particularly, the present invention specifies that the metallographic structure is a texture.

Namely, a stainless steel wire according to the present invention contains chemical compositions: C: 0.01 to 0.25mass %, N: 0.01 to 0.25 mass %, Mn: 0.4 to 4.0 mass %, Cr: 16 to 25 mass %, and Ni: 8.0 to 14.0 mass %, and the balance Fe with impurities. Particularly, C and N satisfy the following inequality; 0.15 mass % ≦C+N <0.35 mass %. Further, it is specified that the metallographic structure consists of 15 vol. % or less martensite phase induced by a drawing and the balance austenite phase, and the stainless steel wire has a texture in which the diffraction intensities of the austenite phase by X-ray diffraction in the longitudinal direction of the steel wire satisfy both I(200)/I(111 )≧2.0 and I(220)/I(111)≧3.0.

Preferably, the stainless steel wire contains at least one of the following constituents: 0.4 to 4.0 mass % Mo, 0.1 to 2.0 mass % Nb, 0.1 to 2.0 mass % Ti, 0.8 to 2.0 mass % Si, in addition to the aforementioned chemical constituents. More preferably, it contains 0.2 to 2.0 mass % Co. Further, the stainless steel wire according to the present invention is suitable for use as a spring blanc.

Hereinafter, the present invention will be described in more detail. At first, there will be described the reason why the stainless steel wire according to the present invention and springs made of the stainless steel wire exhibit excellent mechanical characteristics (particularly, fatigue resistance) and excellent corrosion resistance.

By adding interstitial solid-solution elements such as C and N into the austenite phase which is the base, there are the effect of stabilizing the austenite phase (γ phase), the solid-solution hardening effect of generating strains in the crystal lattice for hardening it and the pinning effect of dislocations in the crystal grain (Cottrell atmosphere). Accordingly, the stainless steel wire according to the present invention containing certain amounts of C and N and a spring made of the stainless steel wire has excellent corrosion resistance and mechanical characteristics (fatigue strengths and tensile strengths), by virtue of the synergistic effect of the γ-phase stabilization, the solid-solution hardening and the dislocation-pinning effect. Particularly, by adding ferrite stabilizer such as Mo, Ti, Nb, Si for causing solid-solution hardening, it is possible to offer excellent corrosion resistance and hydrogen embrittlement resistance equivalent to those of SUS316(JIS), etc., and it is also possible to further enhance the tensile strength and the fatigue strength.

In order to obtain the aforementioned dislocation-pinning effect, particularly, it is effective that the amounts of C and N contained in the stainless steel satisfy the following inequality: 0.15 mass % ≦C+N ≦0.35 mass %. More preferably, the following inequality is satisfied: 0.25 mass % ≦C+N <0.35 mass %. Conventional austenitic stainless steels with excellent corrosion resistance such as SUS304 (JIS) and SUS316 have C+N contents of less than 0.15 mass %. The present inventors revealed from studying that C+N contents equal to or higher than 0.15 mass % can cause dislocation pining effect more effectively. However, C+N contents above 0.35 mass % will cause lacks of toughness. Therefore, the upper limit thereof is set to 0.35 mass %.

The most characteristic point of the stainless steel wire according to the present invention is that it has a texture which causes the austenite phase to exhibit diffraction intensities satisfying both I(200)/I(111)≧2.0 and I(220)/I(111)≧3.0 from an X-ray diffraction in the longitudinal direction of the steel wire. The stainless steel wire according to the present invention includes a stabilized austenite phase, and the austenite phase forms about 100% of the metal lographic structure. When a drawing is applied to such a stabilized austenitic stainless steel, if the reduction in area exceeds a certain amount, this will create a texture having a crystalline orientation invariant in the longitudinal direction of the steel wire (the direction of drawing). The texture has a crystalline orientation aligned in a certain direction, thus reinforcing the structure. Further, the present inventors conducted studies and obtained knowledge that, when the structure reinforced by the texture and mechanical characteristics enhanced by the existence of interstitial solid-solution elements such as C and N are both attained, the fatigue strength can be further enhanced. Therefore, the present invention specifies that the stainless steel wire has a texture as well as the aforementioned composition. Particularly, the crystalline structure of the austenite phase is a face-centered cubic lattice and thus the crystalline orientation thereof is aligned in the directions of [111] and [100]. Consequently, it is advantageous that the austenite phase exhibits diffraction intensities satisfying both I(200)/I(111)≧2.0 and I(220)/I(111)≧23.0, from an X-ray diffraction in the steel-wire longitudinal direction conducted as a concrete method for confirming the formation of the texture. When I(200)/I(111) is below 2.or when I (220)/I(111) is below3.0, it is not possible to easily attain significant enhancement of the fatigue strength. Further, the I(200) is the maximum peak intensity obtained by the X-ray diffraction, with respect to the (200) plane. Similarly, the I(220) is the maximum peak intensity obtained by the X-ray diffraction, with respect to the (220) plane. The I(111) is the maximum peak intensity obtained by the X-ray diffraction, with respect to the (111) plane.

In order to provide a texture which causes the austenite phase to exhibit X-ray diffraction intensities satisfying both I(200)/I(111)≧2.0 and I(220)/I(111)≧3.0, for example, the condition of the drawing can be controlled. More specifically, for example, a hard drawing with a total reduction in area above 60% and particularly 70% or more can be performed. As a drawing method for example, the drawing may be performed using such as a drawing die with an adjusted hole shape. As a drawing die, for example, there is a die with an approach angle 2θ of 11 to 14 degrees, a bearing length of 0.5D (D: drawing hole diameter) and a back relief angle of about 90 degrees. Also, it is possible to use a drawing die which is generally used for drawing. When such a drawing die is used to perform a drawing, the total reduction in area is preferably 70% or more and more preferably 85% or more. Further, a drawing process using a roller die can be performed. In this case, the total reduction in area is preferably 80% or more and more preferably 90% or more. The aforementioned reduction in area may be properly changed depending on the drawing method and the sizes of the wire. Further, the present invention also controls the composition, thereby attaining the aforementioned desired texture without significantly increasing the reduction in area as in the Patent Literatures 4 and 5. However, drawing which provide a total reduction in area within the range of 0 to 60% cannot provide the desired texture as previously described.

By controlling the drawing method and the reduction in area as described above, a desired texture can be provided. A drawing process using a roller die causes both extending and compressing plastic working, while a drawing process using a drawing die causes only extending plastic working. Therefore, drawing processes using a drawing die can provide a crystalline orientation aligned in the slip direction more easily, thereby easily offering the effects of textures. Further, according to the present invention, the reduction in area may be set to within the aforementioned range, thus enabling provision of stainless steel wires and springs with wire diameters of φ0.5 mm or more.

Further, according to the stainless steel wire according to the present invention, the constituents and the drawing condition are adjusted, such that the martensite phase induced by the drawing makes up 15 vol. % or less of the entire steel, in order to enhance the fatigue strength. If the martensite phase induced by the drawing makes up a greater part, namely more than 15 vol. %, this will facilitate the formation of the martensite phase, due to stresses which are repeatedly imposed, at concentrated slip bands caused by fatigues at the stainless steel surface. The martensite phase induced by the fatigues becomes a factor of toughness reduction and progression to a fracture starting point. Consequently, in order to effectively suppress the formation of the martensite phase due to fatigue, the present invention specifies that the amount of the martensite phase induced by the drawing is 15 vol. % or less. The smaller the amount of the martensite phase induced by the drawing, the more preferable is.

The amount of martensite phase induced by the aforementioned drawing is affected by both the stability of the austenite phase and the temperature during the working. For example, in the case where the working is performed at an ordinary room temperature, in order to control the amount of the martensite phase induced by the drawing to 15 vol. % or less, it is effective to set the C+N content to within the above specified range.

Further, the balance of the metallographic structure of the stainless steel wire according to the present invention other than the martensite phase substantially consists of the austenite phase, and unavoidable phases other than the martensite phase and the austenite phase are also contained therein.

In order to further enhance the fatigue strength, it is preferable that the surface roughness Rz of the stainless steel wire in the direction of drawing (the longitudinal direction of the steel wire) is 20 micrometers or less. More preferably, the surface roughness Rz is 4.O micrometers or less. The stresses imposed on the stainless steel wire increase and decrease and particularly, if such increase and decrease of stresses repeatedly occur within a relatively short term, this will cause stress concentrations at flaws or the like at the steel wire surface. As a result, local slip concentrations occur, thus resulting in embrittlement. The present invention reduces the surface roughness of the steel wire to alleviate stress concentrations, thereby improving the fatigue strength. The surface roughness Rz may be controlled to 20 micrometers or less through conventionally-performed process controls such as the handling of the steel wire during thermal treatments, as well as the configuration of the drawing dies and the drawing speed. Also, electrolytic polishing may be applied to enhance the smoothness in order to further enhance the fatigue strength.

The enhancement of the fatigue strength as aforementioned may be attained for steel wires having deformed cross sectional form such as elliptical shapes, trapezoidal shapes, square shapes, rectangular shapes, etc., as well as steel wires having round-shaped cross sectional areas perpendicular to the longitudinal direction of the steel-wire (the direction of drawing).

The stainless steel wire according to the present invention is most suitable for springs. When a spring is formed from the stainless steel wire according to the present invention, it is preferable to apply Ni plating to the surface of the stainless steel wire with the amount of adhered Ni of 0.03 to 5.0 g/m². Stainless steel wires with high strengths such as that according to the present invention are prone to react with cemented carbide chips used during the spring working and are prone to be seized, thereby tending to have varying free lengths after the spring working. In order to alleviate such free length variations, it is effective to decrease the tensile strength. However, decrease of the tensile strength will degrade the characteristics of the entire spring. Namely, this will degrade the fatigue strength. Therefore, in order to effectively suppress seizure during the spring working, the present invention forms a Ni-plated layer on the surface of the stainless steel wire to enhance the smoothness of the steel-wire surface. The minimum amount of plated Ni which can prevent seizure is set to 0.03 g/m² while the upper limit thereof is set to 5.0 g/m² in consideration of adverse influences on the drawing and cost increases. More preferably, the amount of adhered Ni is within the range of 0.1 to 4.0 g/m².

The spring according to the present invention can be provided by applying spring workings such as coiling to the aforementioned stainless steel wire. Particularly, by applying a thermal treatment after the aforementioned spring working, it is possible to further enhance the mechanical characteristics, particularly the tensile strength. Thus, according to the method of manufacturing spring according to the present invention, it is specified that annealing is applied to the aforementioned stainless steel wire, after the application of the spring working thereto.

This annealing can be pinned almost all dislocations to reinforce the structure, thus increasing the tensile strength. More specifically, the tensile strength can be enhanced by 100 to5O0MPa from that before the thermal treatment. Particularly, by applying low-temperature annealing at a temperature within the range of 400 to 600° C., it is also possible to enhance the fatigue strength, as well as the tensile strength. If the thermal-treatment temperature is below 400° C., the tensile strength cannot be enhanced and also the fatigue strength will be low. On the other hand, if the temperature is above 600° C., the tensile strength can be enhanced to some degree, but the fatigue strength will be degraded due to degradation of the toughness. It is particularly preferable that the temperature is about 500° C. Further, this annealing can eliminate strain induced by the spring working.

Hereinafter, there will be described the selection of constituent elements and the reason of the limitation of the range of the constituents.

C is a strong austenite-stabilizing element. Further, C is interstitially solid-soluble into crystal lattices and offers the effect of causing strains for reinforcing them. Further, C has the effect of forming a Cottrell atmosphere, thus pinning dislocations in the metallographic structure. However, if an excessive amount of C is added thereto, this will facilitate the formation of Cr carbides. If Cr carbides exist at crystal grain boundaries, Cr-deficient layers will be formed around grain boundaries, degrading the toughness and the corrosion resistance, since the intra-grain diffusion rate of Cr is low in the austenite. This phenomenon can be suppressed by adding Nb or Ti. However, if an excessive amount of added elements such as Nb or Ti exists, this will cause instability of the austenite phase. Therefore, the present invention specifies that the effective C content be within the range of 0.01 to 0.25 mass %.

N is a strong austenite-stabilizing element and also an interstitial solid-solution hardening element, similarly to C. Further, N is a Cottrell-atmosphere-forming element. However, the solid solution thereof into the austenite phase is limited and large amounts of addition thereof (0.20 mass % or more, particularly 0.25 mass % or more) will cause occurrences of blowholes during melting and casting. This phenomenon can be alleviated to some degree by adding elements with high affinities for N, such as Cr or Mn, for raising the solubility limit of N. However, if an excessive amount of such elements is added thereto, it will be necessary to control the temperature and the atmosphere during melting, which may increase the cost. Accordingly, the present invention specifies that the N content is within the range of 0.01 to 0.25 mass %.

Mn is used as a deoxidizer during melting and refining. Further, Mn is effective in phase-stabilizing the γ phase of austenitic stainless steels and may serve as a substitute element for Ni which is expensive. Further, Mn has the effect of raising the limit of solid solution of N into the austenite phase as previously described. However, Mn will adversely affect the oxidation resistance at high temperature, and therefore, the Mn content is set to within the range of 0.4to4.0mass %. Further, in placing special emphasis on the corrosion resistance, it is preferable that the Mn content is within the range of 0.4 to 2.0 mass %. On the other hand, in order to raise the limit of solid solution of N, namely in order to significantly reduce micro blowholes of N, it is significantly effective to add Mn with an Mn content of within the range of 2.0 to 4.0 mass %. However, this may involve some degradation of the corrosion resistance. Therefore, the Mn content may be adjusted depending on the purpose.

Cr is a main constituent element of austenitic stainless steels and an effective element in providing heat resistance and oxidation resistance. In the present invention, the Ni equivalent weight and the Cr equivalent weight were calculated from other constituent elements and the Cr content was set to 16 mass % or more for providing a required heat resistance in consideration of the phase stability of the γ phase and set to 25 mass % or less in consideration of toughness degradation.

Ni is effective instabilizing the γ phase. In the present invention, when the N content is greater than 0.2 mass %, an excessive Ni content causes occurrences of blowholes. In this case, it is effective to add Mn with a high affinity for N. It is necessary to add Ni in consideration of the amount of added Mn in order to form the austenitic stainless steel. Therefore, the Ni content is set to 8.0 mass % or more for stabilizing the γ phase and also set to 14.0 mass % or less for suppressing blowholes and suppressing cost increases. While it is preferable that the Ni content is within the range of 8.0 to 14.0 mass % as described above, the range of less than 10 mass % enables easily causing solid solution of N during the melting-casting process, thereby offering the large advantage of cost reduction.

Mo is substitutionally solid-soluble into the γ phase and significantly contributes to the enhancement of the corrosion resistance. Further, Mo coexists with N within steels to contribute to the enhancement of the fatigue strength. Therefore, the Mo content is set to 0.4 mass % or more, which is a minimum content necessary for enhancing the corrosion resistance and also set to 4.0 mass % or less in consideration of degradation of the workability.

Nb is solid-soluble into the γ phase similarly to Mo and enhances the mechanical characteristics to largely contribute to the enhancement of the fatigue strength. Further, Nb has a high affinity for N and C as previously described and is micro-precipitated within the γ phase, thus contributing to the enhancement of the sag resistance at high temperatures. Further, Nb has the effects of suppressing the coarsening of crystal grains and suppressing grain boundary precipitation of Cr carbides. However, an excessive amount of addition thereof will cause precipitation of a Fe₂Nb (Laves) phase. In this case, the strength is expected to be degraded and thus the Nb content is set to within the range of 0.1 to 2.0 mass %.

Ti is a ferrite-forming element similarly to Mo, Nb and Si which will be described later and is solid soluble into the γ phase to enhance the mechanical characteristics. However, Ti degrades the stability of the γ phase and the Ti content is set to within the range of 0.1 to 2.0 mass %.

Si is solid soluble to offer the effect of enhancing mechanical characteristics. Further, Si is usable as a deoxidizer during melting and refining. Ordinary austenitic stainless steels contain about 0.6 to 0.7 mass % Si. Further, the Si content is required to be 0.8 mass % or more in order to provide mechanical characteristics through solid solution hardening, while the upper limit thereof is set to 2.0 mass % in consideration of toughness degradation.

Co is an austenite-stabilizing element. Co cannot offer the solid-solution hardening effect as much as that of ferrite-forming elements such as aforementioned Mo, Nb, Ti, and Si, but can offer the effect of reducing the stacking fault energy of materials. Namely, contained Co enables introduction of a large amount of edge dislocations which form the Cottrell atmosphere into materials. The effect of introducing dislocations and the existence of Cottrell-atmosphere-forming elements such as C and N enhance the mechanical characteristics. Further, Co has the effect of suppressing corrosion by chlorine ions. However, excessive amounts of addition of Co will degrade the acid-resistance against sulfuric acid and nitric acid and the atmospheric corrosion resistance, and therefore the Co content is set to within 0.2 to 2.0 mass %.

The balance other than the above-specified constituent elements consists of Fe and impurities. Here, the impurities include elements (inevitable elements) other than the elements which are meaningfully contained. Accordingly, the balance substantially consists of Fe and unavoidable elements.

### EFFECT OF THE INVENTION

As described above, the stainless steel wire according to the present invention offers the specific effects of exhibiting enhanced mechanical characteristics and exhibiting excellent fatigue resistance, by virtue of the reinforced base of the Fe-based austenitic stainless steel, solid solution strengthening by added interstitial solid solution elements such as C and N and the texture. Particularly, by solid-solution-strengthening through the addition of ferrite-forming elements such as Mo, Ti, Nb and Si and by further adding Co, the fatigue characteristics can be further enhanced.

Further, from the aforementioned stainless steel wire having excellent corrosion resistance and excellent fatigue characteristics, it is possible to provide a spring having both excellent corrosion resistance and excellent fatigue characteristics. Particularly, by applying low-temperature annealing at a proper temperature to dislocations which have been introduced into the metallographic structure during plastic working such as a drawing or a spring working, it is possible to form a Cottrell atmosphere with C and N for reinforcing the structure to facilitate the enhancement of the mechanical characteristics, thus providing a spring with an excellent fatigue strength.

Further, with the present invention, it is possible to provide a stainless steel wire and a spring with excellent characteristics as previously described, without performing temperature control during the drawing and high-level adjustment of constituents during refining as conventional. Namely, the present invention can reduce the cost increase without utilizing a specific manufacturing method. Therefore, the present invention can realize high productivity and thus is industrially valuable.

The present invention as described above can provide components and springs usable at portions in an automobile and a domestic electric appliance, etc., which require high fatigue strengths, with a low cost.

### BEST MODE FOR CARRYING OUT THE INVENTION

Hereinafter, embodiments of the present invention will be described.

### Test Example 1

Rolled wires were manufactured by applying melting-casting, forging and hot rolling to steel materials having chemical constituents (a balance: Fe and unavoidable impurities) represented in Table 1, wherein the rolled wires had a round-shaped cross sectional area (with a wire diameter of φ7.0 mm) perpendicular to the longitudinal direction of the steel wire. Then, a drawing was repeatedly applied to these rolled wires and further a solid-solving thermal treatment was applied thereto to fabricate stainless steel wires having a wire diameter of φ2.0 mm (with a total reduction in area of about 92%). Further, by varying the timing of applying the solid-solving heat treatment, the final reduction in area was varied to vary the degree of alignment of crystalline orientations of the texture. Further, in the present example, the drawing was performed by using a drawing die employed in general for drawing.

TABLE 1
CHEMICAL CONSTITUENTS (MASS %) OF STAINLESS STEEL WIRE

| Type of steel | C | Si | Mn | Ni | Cr | Mo | Nb | Ti | Co | Al | N | C + N |
|---|---|---|---|---|---|---|---|---|---|---|---|---|
| a | 0.07 | 0.37 | 1.25 | 8.34 | 18.17 | 0.16 | — | — | — | — | 0.17 | 0.24 |
| b | 0.07 | 0.37 | 1.21 | 10.34 | 17.80 | 1.5 | — | — | — | — | 0.20 | 0.27 |
| c | 0.07 | 0.37 | 1.24 | 8.45 | 18.17 | — | 1.0 | — | — | — | 0.21 | 0.28 |
| d | 0.08 | 0.37 | 1.31 | 8.52 | 18.17 | — | — | 0.5 | — | — | 0.20 | 0.28 |
| e | 0.07 | 0.95 | 1.11 | 8.04 | 18.17 | — | — | — | — | — | 0.19 | 0.27 |
| f | 0.07 | 0.89 | 1.26 | 8.34 | 18.17 | 1.5 | — | — | — | — | 0.21 | 0.28 |
| g | 0.07 | 0.90 | 1.25 | 8.34 | 18.17 | 0.5 | — | — | 0.5 | — | 0.19 | 0.26 |
| h | 0.07 | 0.28 | 1.21 | 8.64 | 18.32 | 0.22 | — | — | — | — | 0.02 | 0.09 |
| i | 0.10 | 0.25 | 1.31 | 8.30 | 18.56 | 0.20 | — | — | — | — | 0.27 | 0.37 |
| j | 0.04 | 0.61 | 1.39 | 11.76 | 17.72 | 2.10 | — | — | — | — | 0.02 | 0.6 |
| k | 0.08 | 0.17 | 0.80 | 8.08 | 16.48 | — | — | — | — | 1.2 | 0.01 | 0.10 |

In the Table 1, the steel of type h is SUS304 which is an ordinary metastable austenitic stainless steel, the steel of type j is SUS316 which is a stabilized austenitic stainless steel, and the steel of type k is SUS63IJ1(JIS) which is a precipitation-hardened stainless steel.

Low-temperature annealing (aging treatment) was applied to the resultant stainless steel wires with a wire diameter of φ2.0 mm, wherein this annealing represented the annealing for eliminating strains after the spring working. For the sample No. 11 using the steel of type k (SUS 631J1), 475° C.×60 minutes was adopted, wherein this condition was an ordinary annealing condition. As the annealing condition for the other steel wires, 400° C.×30 minutes was adopted, wherein this condition was an ordinary annealing condition adopted generally for SUS304 and SUS316. The retaining time (30 or 60 minutes) for low-temperature annealing was adopted in consideration of the wire diameter.

For the respective stainless steel wires which have been subjected to the low-temperature annealing, X-ray diffraction intensities, the amount of martensite phase contained therein (α′ amount) wherein such martensite phase was induced by the drawing, the surface roughness, the tensile strengths before and after the aging treatment, and the fatigue limit were determined. The fatigue limit was determined with Nakamura-type rotating bending fatigue tests, after the determination of diffraction intensities. The surface roughness Rz of each stainless steel wire was determined in the longitudinal direction of the steel wire, using a tracer-type roughness tester. In the present example, the surface roughness was controlled to 20 micrometers or less by process control. Table 2 presents the ratios of maximum peak intensities for the respective planes obtained from X-ray diffraction, more specifically the I(200)/I(111) ratio and the I(220)/I(111) ratio, the α′ amount (vol. %), the surface roughness Rz (micrometer), the tensile strength (MPa) and the result of the fatigue tests, for the respective stainless steel wires. In the present example, the X-ray diffraction intensity ratios were determined by wide-angle measurements using XRD (RINT: a wide-angle goniometer). The condition of the measurements is described below.

Used X-ray: Cu-Kα

Condition of Excitation: 50 kV, 200 mA

Slit: DS1° RS 0.15 mm SS1°

Range of Measurement: 2θ=30 to 100 degrees

Scanning Speed: 6 degrees/min.

Step Width: 0.02 degree

Number of Accumulations: 3

TABLE 2

| | Type | | Annealing | | | α′ | Surface | Tensile | Tensile | Fatigue |
|---|---|---|---|---|---|---|---|---|---|---|
| | of | Reduction | temperature | I(200)/ | I(220)/ | amount | roughness | strength | strength | limit |
| No. | steel | in area | (° C.) | I(111) | I(111) | (vol %) | Rz (μm) | (MPa) | after aging | (MPa) |
| 1 | a | 92 | 400 | 2.6 | 3.6 | 9 | 15.4 | 1936 | 2245 | 550 |
| 2 | b | 92 | 400 | 2.8 | 3.8 | 2 | 16.4 | 1981 | 2258 | 580 |
| 3 | c | 92 | 400 | 3.0 | 4.1 | 0 | 14.8 | 2002 | 2269 | 590 |
| 4 | d | 92 | 400 | 2.9 | 4.0 | 0 | 15.1 | 2012 | 2273 | 580 |
| 5 | e | 92 | 400 | 2.8 | 4.3 | 0 | 15.4 | 1973 | 2244 | 580 |
| 6 | f | 92 | 400 | 2.5 | 3.8 | 0 | 16.4 | 2045 | 2283 | 610 |
| 7 | g | 92 | 400 | 2.8 | 3.9 | 0 | 15.6 | 1975 | 2294 | 650 |
| 8 | h | 92 | 400 | 2.3 | 3.8 | 67 | 15.1 | 2108 | 2203 | 360 |
| 9 | i | 92 | 400 | 2.5 | 4.2 | 0 | 14.8 | 1964 | 2298 | 380 |
| 10 | j | 92 | 400 | 2.4 | 3.9 | 0 | 15.3 | 1890 | 2001 | 350 |
| 11 | k | 92 | 475 | 2.6 | 3.95 | 92 | 15.5 | 2256 | 2502 | 370 |

From the aforementioned results of the tests, it can be seen that the samples Nos. 1 to 7 having specific chemical constituents and having a texture satisfying both I (200)/I(111)≧2.0 and I(220)/I(111)≧3.0 exhibited higher fatigue strengths than those of the samples Nos. 8 to 11. Particularly, it can be seen that the samples Nos. 2 to 6 containing specific amounts of Mo, Ti, Nb and Si and the sample No. 7 containing Co had higher fatigue strengths. Further, it can be seen that low-temperature annealing at proper temperatures enhanced the tensile strength.

On the contrary, the sample No. 9 containing an excessive amount of N contained residual blowholes formed during the melting-casting, and there were fatigue fractures originated from cracks therein. Such blowholes can be suppressed by sophisticated melting techniques and wire-drawing techniques, which is, however, undesirable in terms of the cost. The samples Nos. 8 and 11 having C+ N contents of less than 0.15 mass % exhibited insufficiently the effect of fixating dislocations and contained a large amount of the martensite phase induced by the drawing, thus having low fatigue limits. The samples Nos. 9 and 10 having C+ N contents of more than 0.35 mass % were degraded in toughness, thus having low fatigue limits. Further, the samples satisfying any one of I(200)/I(111)≧2.0 and I(220)/I(111)≧3.0 were difficult to manufacture.

### Test Example 2

Samples were manufactured using the steel of type a manufactured in the aforementioned test example 1, wherein the states of the formation of textures in the samples were varied by varying the reduction in area and the drawing method. Further, evaluations of the fatigue strengths were conducted similarly to in test example 1. Table 3 represents the results. Two types of drawing method using a drawing die and a roller die were performed.

TABLE 3

| | | | | | | | | | | Tensile | |
|---|---|---|---|---|---|---|---|---|---|---|---|
| | Type | | | Annealing | | | α′ | Surface | Tensile | strength | Fatigue |
| | of | | Reduction | temperature | I(200)/ | I(220)/ | amount | roughness | strength | after | limit |
| No. | steel | Dies | in area | (° C.) | I(111) | I(111) | (vol %) | Rz (μm) | (MPa) | aging | (MPa) |
| 1 | a | Drawing | 90 | 400 | 2.6 | 3.6 | 9 | 15.4 | 1936 | 2245 | 550 |
| 12 | a | Drawing | 70 | 400 | 2.1 | 3.4 | 5 | 15.3 | 1734 | 2012 | 500 |
| 13 | a | Drawing | 50 | 400 | 1.6 | 2.3 | 0 | 15.6 | 1511 | 1707 | 390 |
| 14 | a | Roller | 90 | 400 | 2.3 | 3.2 | 5 | 14.8 | 1824 | 2103 | 510 |
| 15 | a | Roller | 70 | 400 | 1.8 | 2.9 | 4 | 14.6 | 1672 | 1925 | 410 |
| 16 | a | Roller | 50 | 400 | 1.4 | 2.2 | 0 | 14.8 | 1475 | 1529 | 390 |

From Table 3, it can be seen that there is a tendency that the formation of texture is advanced and thus the fatigue strength is increased, with increasing the reduction in area during the drawing, not depending on the drawing method. Further, it can be seen that the drawing method using the drawing die can raise the fatigue limit more easily.

### Test Example 3

Samples were manufactured using the steel of type a manufactured in the aforementioned test example 1, wherein the smoothness (surface roughness Rz) of the surfaces of the stainless wires were varied. Further, evaluations of the fatigue strengths were conducted similarly to in test example 1. Table 4 represents the results. The variation of the smoothness (surface roughness Rz) was caused by applying electropolishing or by coarsening using a sand paper.

TABLE 4

| | | | | | | | | | | Tensile | |
|---|---|---|---|---|---|---|---|---|---|---|---|
| | Type | | | Annealing | | | α′ | Surface | Tensile | strength | Fatigue |
| | of | | Reduction | temperature | I(200)/ | I(220)/ | amount | roughness | stength | after | limit |
| No. | steel | Dies | in area | (° C.) | I(111) | I(111) | (vol %) | Rz (μm) | (MPa) | aging | (MPa) |
| 1 | a | Drawing | 90 | 400 | 2.6 | 3.6 | 9 | 15.4 | 1936 | 2245 | 550 |
| 17 | a | Drawing | 90 | 400 | 2.6 | 3.6 | 9 | 4.1 | 1937 | 2245 | 640 |
| 18 | a | Drawing | 90 | 400 | 2.6 | 3.6 | 9 | 25.4 | 1928 | 2238 | 410 |

From Table 4, it can be seen that the smaller the surface roughness Rz, the more largely the fatigue strength can be enhanced. Further, it can be seen that the surface roughness Rz of 20micrometers or less is effective in enhancing the fatigue strength.

### Test Example 4

Tests similar to test examples 1 to 3 were also performed for a steel wire having an elliptical-shaped cross sectional area with a greater diameter of 3 mm and a smaller diameter of 1.5 mm, perpendicular to the longitudinal direction of the steel wire. The results of the tests were substantially equivalent to those of test examples 1 to 3.

### Test Example 5

Samples were fabricated using the steel of type a manufactured in the aforementioned test example 1, wherein the conditions of the low-temperature annealing for the samples were varied. Evaluations of the fatigue strengths were conducted similarly to in test example 1. Table 5 represents the results.

TABLE 5

| | | | | | | | | | | Tensile | |
|---|---|---|---|---|---|---|---|---|---|---|---|
| | Type | | | Annealing | | | α′ | Surface | Tensile | strength | Fatigue |
| | of | | Reduction | temperature | I(200)/ | I(220)/ | amount | roughness | strength | after | limit |
| No. | steel | Dies | in area | (° C.) | I(111) | I(111) | (vol %) | Rz (μm) | (MPa) | aging | (MPa) |
| 1 | a | Drawing | 90 | 400 | 2.6 | 3.6 | 9 | 15.4 | 1936 | 2245 | 550 |
| 19 | a | Drawing | 90 | 300 | 2.7 | 3.7 | 9 | 15.4 | 1936 | 2010 | 360 |
| 20 | a | Drawing | 90 | 500 | 2.6 | 3.4 | 9 | 15.4 | 1936 | 2365 | 610 |
| 21 | a | Drawing | 90 | 600 | 2.4 | 3.2 | 8 | 15.4 | 1936 | 2304 | 540 |
| 22 | a | Drawing | 90 | 700 | 2.2 | 3.1 | 7 | 15.4 | 1936 | 2255 | 370 |

From Table 5, it can be seen that low-temperature annealing (aging treatment) at temperatures within the range of 400 to 600° C. can enhance the fatigue strength and the tensile strength. Particularly, the sample No. 20 subjected to low-temperature annealing at 500° C. had a tensile strength which was enhanced by 429 MPa and had the greatest fatigue strength.

### Test Example 6

Coated steel wires were manufactured using the steel of type a manufactured in the aforementioned first test example by applying Ni plating on the surfaces of steel wires (the amount of adhered Ni was 1.2 g/m²). Further, in order to evaluate the spring-workability of the coated steel wires including the Ni-plated layer, springs having a coil diameter of 17.5 mm, a free length of 30 mm, a total number of winding of 10.5 and an effective number of winding of 6 were manufactured. The variation of the free lengths of the springs was evaluated. In the present example, the standard deviation was determined as a measure for the evaluation. Table 6 represents the results.

TABLE 6

| | Type | | | α′ | Surface | Tensile | Tensile | | Free-length |
|---|---|---|---|---|---|---|---|---|---|
| | of | I(200)/ | I(220)/ | amount | roughness | strength | strength | Ni | variation |
| No. | steel | I(111) | I(111) | (vol %) | Rz (μm) | (MPa) | after aging | plating | √V(mm) |
| 1 | a | 2.6 | 3.6 | 9 | 15.4 | 1936 | 2245 | Presence | 0.12 |
| 23 | a | 2.6 | 3.6 | 9 | 15.4 | 1936 | 2244 | Absence | 0.35 |

From Table 6, it can be seen that Ni plating applied on the surfaces of steel wires can reduce the variation in the free lengths. Namely, preferable springs can be provided without degrading the spring characteristics (the tensile strength and the fatigue characteristics) . Further, the amount of adhesion was varied and the free-length variation was determined similarly. As a result, when the amount of adhesion was less than 0.03 g/m², the smoothness could not be easily enhanced and seizure occurred, thus resulting in a large variation in the free length. The greater the amount of adhesion, the greater the smoothness is.. However, if the amount of adhesion is more than 5.0 g/m², this will adversely affect the drawing-workability.

### INDUSTRIAL APPLICABILITY

The stainless steel wire according to the present invention and the spring manufactured from the same stainless steel wire have excellent fatigue resistance and excellent corrosion resistance, and therefore are suitable as components for use in automobiles and domestic electric appliances, etc., such as reinforcing wires for torsion bars or wire harnesses, springs such as flexing-springs or compression coiled springs, or high-tensile strength wires for optical fiber cables, etc.

1. A stainless steel wire consisting of 0.01 to 0.25 mass % C, 0.01 to 0.25 mass % N, 0.4 to 4.0 mass % Mn, 16 to 25 mass % Cr, 8.0 to 14.0 mass % Ni and the balance consisting of Fe with impurities, wherein the C+N content satisfies 0.15 mass % ≦C+N ≦0.35 mass %;
said stainless steel wire contains 15 vol. % or less martensite phase induced by drawing and the balance consisting of austenite phase; and
said stainless steel wire has a texture in which the diffraction intensities of the austenite phase by X-ray diffraction in the longitudinal direction of the steel wire satisfy both I(200)/I(111)≧2.0 and I(220)/I(111)≧3.0.

2. The stainless steel wire according to claim 1 further containing at least one of 0.4 to 4.0 mass % Mo, 0.1 to 2.0 mass % Nb, 0.1 to 2.0 mass % Ti and 0.8 to 2.0 mass % Si.

3. The stainless steel wire according to claim 2 further containing 0.2 to 2.0 mass % Co.

4. The stainless steel wire according to claim 1 having a surface roughness Rz of 20 micrometers or less.

5. The stainless steel wire according to claim 1, wherein the cross sectional area perpendicular to the longitudinal direction of the steel wire has an elliptical shape, a trapezoidal shape, a square shape or a rectangular shape.

6. The stainless steel wire according to claim 1, further including an Ni-plated layer with an amount of adhered Ni of 0.03 to 5.0 g/m², on the surface of the steel wire.

7. A spring manufactured using the stainless steel wire according to any one of claims 1 to 6.

8. A method of manufacturing a spring including applying a spring working to the stainless steel wire according to any one of claims 1 to 6 and thereafter performing low-temperature annealing at a temperature within the range of 400 to 600° C.
